(19) United States
(12) Patent Application Publication
(10) Pub. No.: US 2013/0286766 A1
(43) Pub. Date: Oct. 31, 2013

(54) WARM MIX ASPHALT ASSEMBLY AND METHODS THEREOF

(71) Applicants: R. JEFFREY MEEKER, Hatfield, PA (US); FREDERICK E. WALLENQUEST, JR., Point Pleasant Boro, NJ (US)

(72) Inventors: R. JEFFREY MEEKER, Hatfield, PA (US); FREDERICK E. WALLENQUEST, JR., Point Pleasant Boro, NJ (US)

(21) Appl. No.: 13/844,869

(22) Filed: Mar. 16, 2013

Related U.S. Application Data
(63) Continuation-in-part of application No. 13/285,020, filed on Oct. 31, 2011.

(51) Int. Cl. B28C 7/12

(52) U.S. Cl. CPC B28C 7/12
USPC 366/7; 366/25; 366/16

(57) ABSTRACT

Embodiments of the present invention generally relate to a warm mix asphalt assembly and methods of operating the same. More specifically, embodiments of the present invention relate to warm mix asphalt assembly having requisite ultra-low nitrogen oxide emissions. In one embodiment of the present invention, a warm mix asphalt assembly comprises a warm mix asphalt skid, having a water input pipe, a water output pipe and a control apparatus; a burner assembly for drying aggregate, the burner assembly comprising a water line for receiving water from the warm mix asphalt skid; and an asphalt expander and drum assembly having a water line for receiving water from the warm mix asphalt skid.

### CROSS-REFERENCE TO RELATED APPLICATIONS

This application is a continuation in part of U.S. patent application Ser. No. 13/285,020, entitled “Burner Assembly and Methods Thereof,” filed Oct. 31, 2011, the disclosure of which is incorporated by reference herein in its entirety.

### BACKGROUND OF THE INVENTION

1. Field of the Invention

Embodiments of the present invention generally relate to a warm mix asphalt assembly and methods of operating the same. More specifically, embodiments of the present invention relate to warm mix asphalt assembly having requisite ultra-low nitrogen oxide emissions.

2. Description of the Related Art

A number of new technologies have been developed to lower the production and placement temperatures of hot mix asphalt (HMA). Generically, these technologies to reduce production temperatures are referred to as warm mix asphalt (WMA).

WMA is a an asphalt process that decreases asphalt mixing temperatures at the plant by 30° to 100° F. as compared to its hot mix asphalt design. Accordingly, using some lower temperatures, common benefits with WMA include: reduced fumes and emissions at the plant; reduced energy consumption; reduced oxidative hardening of the binder, which could lead to more flexibility of the asphalt and improved resistance to cracking in service, lower production and placement temperatures, lower temperatures and fewer fumes improve the operating environment at the screed and the overall jobsite, and a reduced rate of cooling at the jobsite and improved compaction performance.

Although cooler than an HMA process, even at the temperatures utilized with WMA processes there are often undesirable emissions resulting from the burning of fuels and/or gases. With regard to industrial burners, one of the larger concerns surrounds the level of nitrogen oxides (NOx) emissions. Science has shown that excessive NOx emissions add to problems surrounding acid rain, global warming, plant and foliage growth, and in conjunction with other pollutants, NOx may form toxic chemicals.

Due to these concerns, the Environmental Protection Agency (EPA), as well as many states, have enacted specific guidelines with respect to acceptable NOx emissions being generated by asphalt pavement production plants. For example, the State of New Jersey has set out certain “State of the Art” performance levels for all burners utilized in conjunction with aggregate dryers within the state. In particular, the allowable emissions must be kept below: 35 ppmvd @ 7% O2 using a single natural gas burner; 75 ppmvd @ 7% O2 using a dual fuel burner with natural gas; 100 ppmvd @ 7% O2 using a dual fuel burner with No. 2 fuel oil; and 125 ppmvd @ 7% O2 using a dual fuel burner with any of No. 4 fuel oil, No. 6 fuel oil, or other approved fuel oils. While these limits may not be considered overly excessive regulation, such restrictions will likely

Thus, there is a need for a cost effective warm mix asphalt having requisite ultra-low nitrogen oxide emissions and methods of manufacturing and operating the same.

### SUMMARY OF THE INVENTION

Embodiments of the present invention generally relate to a warm mix asphalt assembly and methods of operating the same. More specifically, embodiments of the present invention relate to warm mix asphalt assembly having requisite ultra-low nitrogen oxide emissions.

In one embodiment of the present invention, a warm mix asphalt assembly comprises a warm mix asphalt skid, having a water input pipe, a water output pipe and a control apparatus; a burner assembly for drying aggregate, the burner assembly comprising a water line for receiving water from the warm mix asphalt skid; and an asphalt expander and drum assembly having a water line for receiving water from the warm mix asphalt skid.

In another embodiment of the present invention, a warm mix asphalt assembly comprises: a warm mix asphalt skid, having a water input pipe, a water output pipe and a control apparatus; a burner assembly for drying aggregate, the burner assembly comprising: a single burner apparatus having a centrifugal blower, a transition section, and a frustoconical stabilizer cone from which a flame may exit the burner assembly; a combustible fuel line having a first end connected to a fuel source, and a second end connected to a nozzle for delivering fuel to a combustion chamber within the single burner apparatus; a compressed air line having a first end connected to a compressed air source, and a second end connected to a nozzle for delivering compressed air to the combustion chamber; and a water line having a first end connected to a water source and a second end connected to a nozzle for delivering water to the combustion chamber; and an asphalt expander and drum assembly, the asphalt expander and drum assembly comprising: a drum; an expanded asphalt injection pipe assembly, connected to a water line, and extending into the drum; a burner apparatus positioned within the drum; and an asphalt delivery pipe for providing asphalt aggregate into the drum.

In yet a further embodiment of the present invention, a method of using a warm mix asphalt assembly while producing low NOx emissions comprises: providing a warm mix asphalt skid, having a water input pipe, a water output pipe and a control apparatus; providing a burner assembly for drying aggregate, the burner assembly comprising: a single burner apparatus having a centrifugal blower, a transition section, and a frustoconical stabilizer cone from which a flame may exit the burner assembly; a combustible fuel line having a first end connected to a fuel source, and a second end connected to a nozzle for delivering fuel to a combustion chamber within the single burner apparatus; a compressed air line having a first end connected to a compressed air source, and a second end connected to a nozzle for delivering compressed air to the combustion chamber; and a water line having a first end connected to a water source and a second end connected to a nozzle for delivering water to the combustion chamber; and providing an asphalt expander and drum assembly, the asphalt expander and drum assembly comprising: a drum; an expanded asphalt injection pipe assembly, connected to a water line, and extending into the drum; a burner apparatus positioned within the drum; and an asphalt delivery pipe for providing asphalt aggregate into the drum; operating the burner assembly; operating the asphalt expander and drum assembly; and introducing water via the warm mix asphalt skid to both the burner assembly and the asphalt expander and drum assembly.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a perspective view of a warm mix asphalt skid in accordance with one embodiment of the present invention;

FIG. 2 depicts a schematic of the internal components of a warm mix asphalt skid in accordance with embodiments of the present invention;

FIG. 3 depicts a system view of a warm mix asphalt assembly in accordance with one embodiment of the present invention; and

FIG. 4 depicts a flowchart of a method of utilizing a warm mix asphalt assembly in accordance with one embodiment of the present invention.

The headings used herein are for organizational purposes only and are not meant to be used to limit the scope of the description or the claims. As used throughout this application, the word may is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention generally relate to a warm mix asphalt assembly and methods of operating the same. More specifically, embodiments of the present invention relate to warm mix asphalt assembly having requisite ultra-low nitrogen oxide emissions.

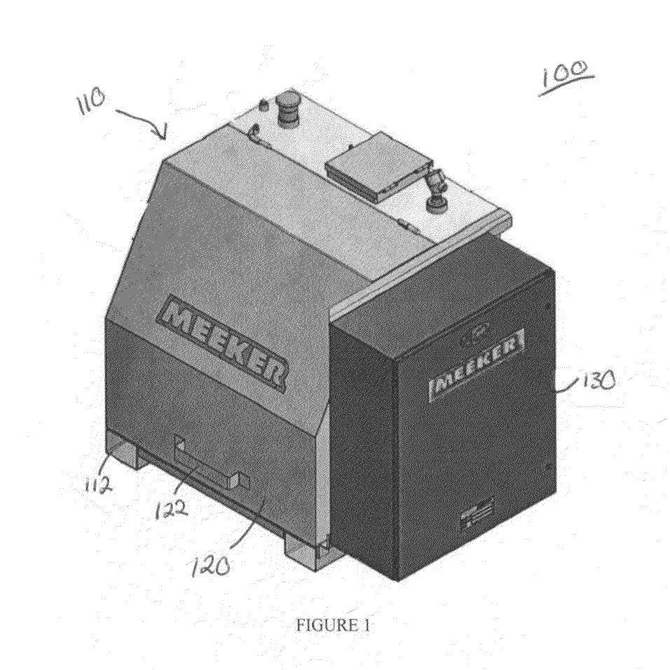

FIG. 1 depicts perspective view of a warm mix asphalt skid in accordance with one embodiment of the present invention. The warm mix asphalt skid 100 generally comprises a water pump and metering apparatus for providing water to an asphalt expander used in a warm mix asphalt production process. In addition, the water pump and metering apparatus of the warm mix asphalt skid provides water to an asphalt burner assembly, as described herein.

As shown, the warm mix asphalt skid 100 comprises a housing 110 having a door 120 for accessing the interior thereof, and a control apparatus 130 positioned on an exterior of the housing 110. The housing 110 may generally comprise a set of skid slots 112 for facilitating the transport of the warm mix asphalt skid 100. In the embodiment shown, the door 120 of the housing 110 comprises a handle 122 for enabling the door to be opened to access the interior thereof. In such embodiment, the door 120 rotates open about a horizontal axis at a top of the housing 110, although any means for accessing the interior of the housing 110 may be suitable for embodiments of the present invention.

The control apparatus 130 may generally comprise a control panel or similar control means, for example, a remote computer, for controlling the operation of the warm mix asphalt skid, as well as the asphalt expander and asphalt burner assembly, as described herein. In many embodiments, the control panel comprises a plurality of control mechanisms for controlling power to particular components, flow rates, valve positions, or the like, as necessary to operate the systems and apparatuses herein. In an alternative embodiment, the control apparatus 130 may be in communication with a remote computer (not shown) via a network connection. In such an alternative embodiment, the control apparatus 130, or a plurality of control apparatuses on a plurality of warm mix asphalt skids, may be monitored and controlled from a centralized location.

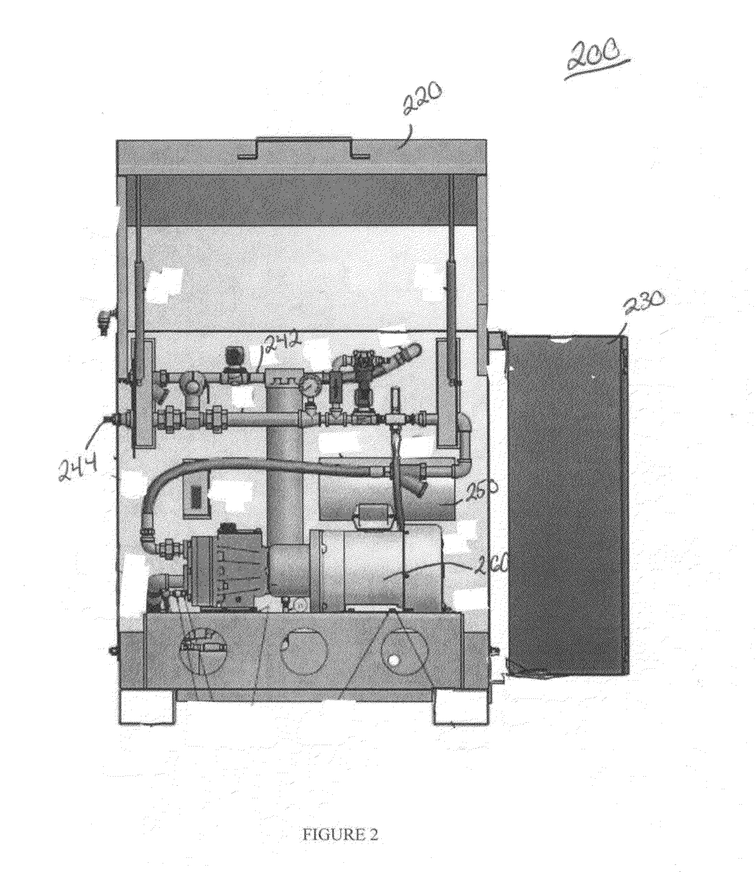

FIG. 2 depicts a schematic of the internal components of the warm mix asphalt skid in accordance with embodiments of the present invention. As shown in the Figure, the warm mix asphalt skid 200 generally comprises an input water pipe 242, an output water pipe 244, a heater apparatus 250, and a motor-pump apparatus 260. In many embodiments, the output water pipe may be connected to a control valve for controlling the amount of water provided to each the asphalt expander and the burner assembly, as described herein.

In certain embodiments, the warm mix asphalt skid may also comprise an asphalt input, asphalt output, and control valve for metering the amount of asphalt and water mix that may enter an asphalt expander. The asphalt input and output may be housed within the housing, or alternatively, may be provided within the asphalt expander assembly and controlled by the control apparatus of the warm mix asphalt skid.

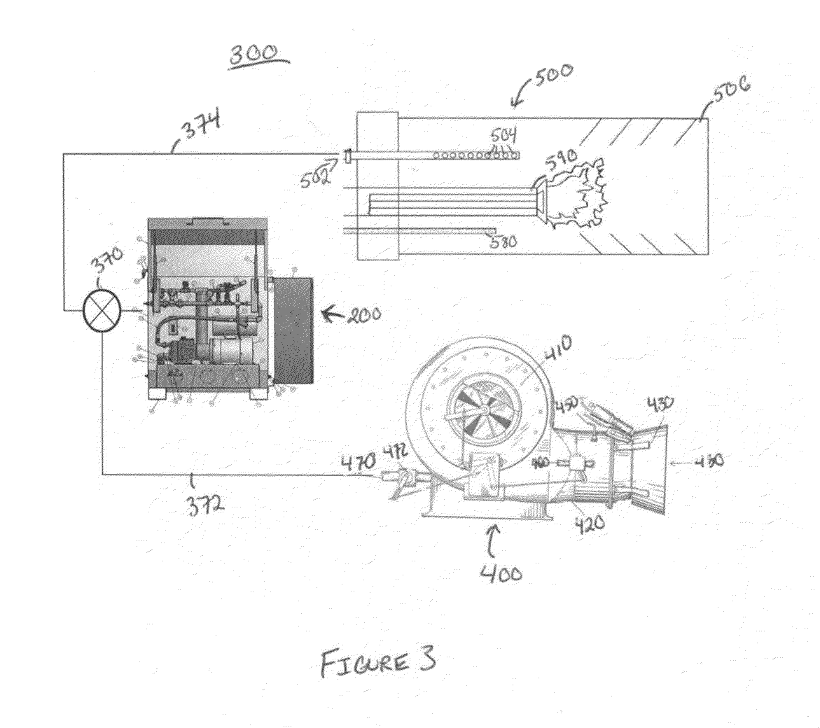

FIG. 3 depicts a system view of a warm mix asphalt assembly in accordance with one embodiment of the present invention. As shown in the Figure, the warm mix asphalt assembly 300 comprises a warm mix asphalt skid 200, a burner assembly 400 and an asphalt drum assembly 500. In addition, the warm mix asphalt assembly 300 may further comprise a control valve 370, a first output line 372 for feeding water to the burner assembly 400 and a second output line 374 for feeding water to the asphalt expander and drum assembly 500.

The asphalt drum assembly 500 may comprise any type of mixing assembly suitable for embodiments of the present invention. For example, although termed an asphalt drum assembly, such component may include any type of mix assembly known in the industry, including for example, any type of drum mix apparatus or batch mix apparatus. A drum mix apparatus may generally comprise a rotary kiln or drum of a counter-flow design or a parallel flow design.

A counter-flow design is a drum in which the burner is located on one end of the drum and the aggregates are entered into the opposite side of the drum. In such an apparatus, the aggregates flow in one direction, and the exhaust gases and products of combustion flow in the opposite direction or counter thereto. A parallel flow drum is a drum in which the burner is located on one end of the drum and the aggregates are entered into the same end as the burner. In such an apparatus, the aggregates flow in one direction and the exhaust gases and products of combustion flow in the same direction or parallel thereto.

In both types of drums, parallel or counter-flow, a liquid asphalt injection pipe 580 is inserted into the drum. This pipe delivers properly proportioned liquid asphalt or bitumen to drum which mixes with the proportioned aggregates, dust, recycled asphalt pavement (RAP), recycled asphalt shingles (RAS), glass, crumb rubber, or any other ingredients to make up the final hot mix asphalt mixture.

Utilizing a batch mix apparatus, aggregates are dried in a rotary kiln or dryer. Once aggregates are dried, the heated aggregate gets conveyed to a batch tower where the materials are stored temporarily until they are needed in a batch. The batch tower a screen on top of the tower which screens or sizes the various heated aggregates. The sized aggregates are deposited into bins or “hot bins” as they are called, which store the heated aggregates until they are needed for a recipe or batch. When a computer calls for a new recipe or batch, the hot bin storage gates are opened to allow the heated aggregates to drop onto a scale, also termed a weigh hopper or aggregate scale. The heated aggregates are weighed per a prescribed recipe.

The liquid asphalt or bitumen, which is stored in heated and insulated tanks, is delivered to the batch tower via a pumping system. When a recipe calls for liquid asphalt, a valve opens in the batch tower and liquid asphalt is pumped into a second scale or asphalt weigh hopper. For each recipe, the liquid asphalt and aggregates are weighed, and once the proper amounts are in the scales, the scales will discharge the ingredients into a mixer. The mixer is typically positioned directly below the asphalt weigh hopper and the aggregate weigh hopper. The aggregates and the liquid asphalt are then mixed together for a predetermined amount of time and the homogenous mixture then gets discharged into a truck or to a finished product storage silo.

With warm mix technology, water is used to foam the liquid asphalt. In a drum mix apparatus, whether counterflow or parallel flow, water is injected into the liquid asphalt pipe and is mixed with the liquid asphalt in a static mixer. The water and the liquid asphalt travel together in the pipe until the two are discharged into the drum. At that point, the water immediately turns to steam creating an expansion of the liquid asphalt. The expanded liquid asphalt is then mixed with the heated aggregates and other ingredients to comprise the finished hot mix asphalt product.

In a batch mix apparatus, warm mix asphalt is made when water is injected into the line between the liquid asphalt scale and the mixer. Liquid asphalt is weighed, and the asphalt scale discharges its contents. However, instead of dropping directly in the mixer, a pump takes the liquid asphalt and puts it under pressure. On the pressure side of the pump, water is injected into the line and the two ingredients travel together into the mixer on the batch tower. Once the water and liquid asphalt discharge into the mixer, the water turns to steam and expands the liquid asphalt. The foamed liquid asphalt cover the aggregates in the mixer making up the warm mix asphalt mixture.

In FIG. 3, the asphalt drum assembly 500 shown is one exemplary embodiment of embodiments of the present invention. The exemplary asphalt drum assembly 500 generally comprises an expanded asphalt injection pipe assembly 502, optionally having a plurality of expanded asphalt foam injection nozzles 504 thereon, a burner apparatus 590, and an asphalt delivery pipe 580 for providing asphalt aggregate into a drum 506. The asphalt injection pipe assembly generally comprises at least a water line (not shown) which receives water via the second output line of the warm mix asphalt assembly.

The burner assembly 400 generally comprises a centrifugal blower 410 for supplying combustion air to the burner, a transition section 420 at a first outlet of the centrifugal blower 410, and a frustoconical stabilizer cone 430 from which the flame 490 may exit the burner assembly 400. A more detailed description of such an embodiment of a basic burner assembly may be found in U.S. Pat. No. 4,298,337, the disclosure of which is incorporated by reference herein in its entirety.

The centrifugal blower 410 any type of blower suitable for embodiments of the present invention. In many embodiments, the centrifugal blower 410 provides air flow of between about 20 osig (ounce/square inch gauge) to about 40 osig. In some embodiments, the centrifugal blower 410 may comprise a structure similar to the devices disclosed by U.S. Pat. Nos. 3,572,963 and 3,572,967, the disclosures of which are incorporated by reference herein in their entireties.

In many embodiments, there are three primary inputs into the burner 400. The first input is a fuel input. The burner 400 is arranged to burn either gas (i.e., natural gas) or a liquid fuel such as no 2. fuel oil. As shown, the gas supply to the burner is introduced through gas line 470. A gas control valve 472 controls the amount of gas being provided to the burner 400 from a gas source (not shown). The gas source may generally comprise a tank, a municipal gas line, or the like, provided such output is suitable for embodiments of the present invention. In certain embodiments, where fuel oil is used instead of gas, a similarly structured fuel oil line may be provided. In additional embodiments, multiple types of gas and/or fuel oil may be utilized by the burner 400, and additional lines may be provided as necessary.

A second input into the burner 400 is a compressed air input. In many embodiments, a compressed air line 450 may also be provided to the burner assembly 400. The compressed air line 450 may be connected to a compressed air source, such as a tank or a device for compressing air (i.e., a pump or the like) (not shown). The compressed air line 450 may generally comprise compressed air at pressures of between about slightly greater atmospheric pressure (i.e., 14.7 psi) to about 100 psi. In many embodiments, the compressed air may be pressurized to between about 25 psi to about 50 psi. In one embodiment, the compressed air may be introduced to the burner at about 40 psi.

A third input into the burner, which is unique to embodiments of the present invention, is a water line 460. The water line 460 may generally be connected to a water source, such as a tank or the like (not shown). In many embodiments, water may be provided through the water line 460 at a pressure ranging from between about slightly greater atmospheric pressure (i.e., 14.7 psi) to about 100 psi. In many embodiments, the water may be pressurized to between about 25 psi to about 50 psi. In one embodiment, the water may be introduced to the burner at about 40 psi. In addition to being pressurized, the water may be provided in a volumetric flow rate of between about 1 gal/min to about 10 gal/min. In some embodiments, the volumetric flow rate of the water is between about 2 gal/min to about 6 gal/min. In one embodiment of the present invention, the volumetric flow rate of the water is about 4 gal/min through the water line 260.

Generally, each of the compressed air line 450, the water line 460 and the gas line 470 terminate via one or more respective nozzles (not shown) into a combustion chamber 480, which is generally located near the interface of the transition section 420 and stabilizer cone 430. Within the combustion chamber 480 is a reaction zone, where the actual chemical combustion of gas/fuel and air takes place. In many embodiments, the compressed air line 450, the gas line 470 and a source of air generated from the centrifugal blower 410 meet within the combustion chamber 480, along with a flame or heat source (e.g., a pilot light) (not shown), to ignite the gas. In accordance with embodiments of the present invention, the pressurized water from the water line 460 is also provided into the combustion chamber at the reaction zone.

In accordance with embodiments of the present invention, there may be numerous other components to the burner assembly 400 commonly utilized with known burners, not described herein for sake of convenience. However, many of such common components (e.g., air intake valves, control mechanisms, etc.) are described in references such as U.S. Pat. No. 4,298,337, as introduced above, the disclosure of which has already been incorporated by reference in its entirety.

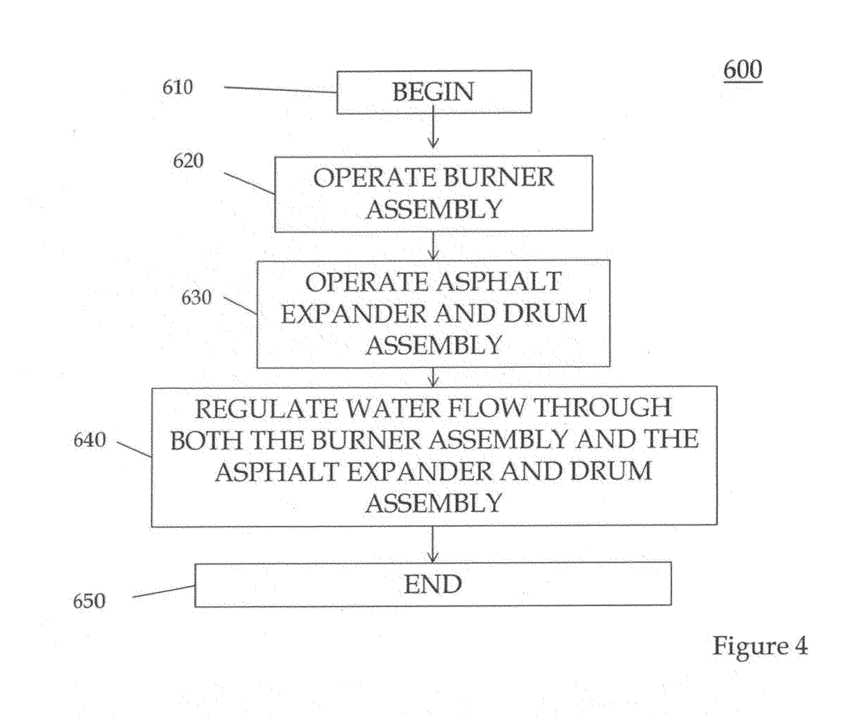

FIG. 4 depicts a flowchart of a method of utilizing a warm mix asphalt assembly in accordance with one embodiment of the present invention. In accordance with one embodiment of the present invention, a method of utilizing a warm mix asphalt assembly 600 begins at step 610 where a warm mix asphalt assembly 300, such as the one disclosed herein with respect to FIG. 3, is provided. In one embodiment, the warm mix asphalt assembly comprises a warm mix asphalt skid, a burner assembly, an asphalt expander and drum assembly, and a control valve for controlling the flow of water into each of the burner assembly and asphalt expander and drum assembly.

At step 620, the burner assembly may be set into operation. In operation, either gas and/or fuel oil is supplied to the burner assembly via a gas/fuel line as described herein. In many embodiments, the gas comprises a natural gas, where supplying the natural gas comprises opening a valve on a gas line connected to a gas source. Similarly, in embodiments where fuel oil is provided, the fuel oil may comprise any of number 2, number 4 or number 6 fuel oil, and supplying such oil may comprise opening a valve on the fuel line connected to a fuel tank or similar source. Supplying the gas/fuel comprises delivering the gas and/or fuel to a combustion chamber within the burner assembly via an exit nozzle.

In addition to fuel, air is supplied to the burner assembly. In accordance with embodiments of the present invention, for purposes of combustion, air may be obtained from multiple sources: air from the centrifugal blower, compressed air from the air line, air entering through the stabilizer cone from the environment, and optionally, air entering through one or more inlets at or near the combustion chamber. In many embodiments, the compressed air may be pressurized to between about 25 psi to about 50 psi. In one embodiment, the compressed air may be introduced to the burner and delivered into the combustion chamber at about 40 psi.

Generally, the gas and/or fuel is combined with the air and is combusted within the combustion chamber to create an external flame. In many embodiments, once the gas and/or fuel is provided to the combustion chamber along with the air, a pilot light or similar type of heat/energy source (e.g., a spark plug) causing ignition of the flammable materials in the combustion chamber. At either the time of combustion or shortly thereafter, water is introduced to the combustion chamber. Generally, the water is delivered directly to the reaction zone where the combustion occurs via a nozzle on the end of the water line. In many embodiments, supplying the water comprises opening a valve on the water line connected to a water source. In many embodiments, the water may be pressurized to between about 25 psi to about 50 psi, having a volumetric flow rate of between about 2 gal/min to about 6 gal/min. In one embodiment, the water may be introduced to the burner at about 40 psi, having a volumetric flow rate of about 4 gal/min through the water line.

By combining the combustible gas/fuel with the air and water, the resulting flame burns sufficiently hot to remove moisture from drying aggregate as commercially intended, but without producing dangerous levels of NOx emission. In one exemplary and experimental embodiment of the present invention, the resulting NOx emissions were kept under about 75 ppm. In other exemplary embodiments, the resulting NOx emissions we kept under about 50 ppm. In addition to the NOx emissions, embodiments of the present invention keep other dangerous emissions such as CO and VOC underneath 250 ppm and 125 ppm, respectively.

At step 630, the asphalt expander and drum assembly may be set into operation. In operation, the expanded asphalt injection pipe assembly supplies expanded asphalt foam to the drum via an asphalt expander. The asphalt delivery pipe generally provides asphalt aggregate from an asphalt source into the drum. As asphalt aggregate passes the burner, expanded asphalt foam is forced from the expanded asphalt foam injection nozzles to coat the aggregate with expanded asphalt foam in the process of creating warm mix asphalt.

At step 640, water flow from the warm asphalt mix skid may be regulated to the burner assembly and the asphalt drum assembly. In many embodiments, as water exits the water output pipe of the warm asphalt mix skid, it is directed by the control valve to both the burner assembly and the asphalt expander and drum assembly, as desired by the operator. The water flow rate from the water output pipe and through the control valve may be controlled via the control assembly. As such, an operator may be able to monitor the performance of the burner assembly and asphalt expander and drum assembly individually, and determine whether the performance should be altered vis-à-vis the water flow rate to the respective apparatus.

The method 600 ends at step 650.

Embodiments of the present invention allow for the production of warm mix asphalt and the lowering of NOx gases simultaneously or separately. In one exemplary embodiment, a warm mix system uses control valves and PLC programming to allow for the simultaneous production of warm mix asphalt and also the injection of water into the burner to lower NOx emissions. The warm mix system uses flow control to regulate the amount of water going into the liquid asphalt pipeline, and the amount of water to be injected is based upon the amount of liquid asphalt called for in the recipe or mix design. For example, is 5% liquid asphalt is needed for a particular recipe, the plant computer will turn on the liquid asphalt pump to deliver 5% liquid asphalt to 95% other ingredients. Generally, the water is measured in as a percentage of the liquid asphalt. For example, water may be injected into the liquid asphalt pipeline at 1% of the liquid asphalt percentage. In real numbers, for 2000 lbs of hot mix asphalt, 1900 lbs would be other ingredients, 100 lbs would be liquid asphalt and 1 lb would be water (to make the liquid asphalt).

The amount of water injected into the burner nozzle may be controlled by the burner control at the plant. The burner control operates the starting, stopping, and modulation of the burner firing rate as conditions change in the aggregate dryer (i.e., in a batch plant) or drum (i.e., in a drum mix plant). The firing rate is usually controlled by the aggregate discharge temperature of the finished hot mix asphalt out of a drum plant or the heated aggregate out of the batch plant dryer. By utilizing embodiments of the present invention, water may be added into the burner nozzle by way of the position of the control valve for the fuel. Once the fuel valve opens (e.g., for natural gas or liquid fuels), the water control valve will open allowing flow of water to the burner nozzle. In many embodiments, the flow rate will stay consistent with the fuel valve position, and when the fuel valve closes (i.e., the flow rate becomes zero), the water valve will also close.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A warm mix asphalt assembly comprising:
a warm mix asphalt skid, having a water input pipe, a water output pipe and a control apparatus;
a burner assembly for drying aggregate, the burner assembly comprising a water line for receiving water from the warm mix asphalt skid; and
an asphalt expander and drum assembly having a water line for receiving water from the warm mix asphalt skid.

2. The warm mix asphalt assembly of claim 1, wherein the burner assembly comprises:
a single burner apparatus having a centrifugal blower, a transition section, and a frustoconical stabilizer cone from which a flame may exit the burner assembly;
a combustible fuel line having a first end connected to a fuel source, and a second end connected to a nozzle for delivering fuel to a combustion chamber within the single burner apparatus;
a compressed air line having a first end connected to a compressed air source, and a second end connected to a nozzle for delivering compressed air to the combustion chamber; and
a water line having a first end connected to a water source and a second end connected to a nozzle for delivering water to the combustion chamber.

3. The warm mix asphalt assembly of claim 1, wherein the asphalt expander and drum assembly comprises:
a drum;
an expanded asphalt injection pipe assembly having a plurality of expanded asphalt foam injection nozzles thereon, extending into the drum;
a burner apparatus positioned within the drum; and
an asphalt delivery pipe for providing asphalt aggregate into the drum.

4. The warm mix asphalt assembly of claim 1, further comprising:
a control valve for controlling an amount of water provided to each the asphalt expander and drum assembly and the burner assembly.

5. The warm mix asphalt assembly of claim 4, further comprising a first output line for feeding water from the control valve to the burner assembly.

6. The warm mix asphalt assembly of claim 5, further comprising a second output line for feeding water from the control valve to the asphalt expander and drum assembly.

7. The warm mix asphalt assembly of claim 1, wherein the control apparatus comprises a control means for regulating water flow rates to the burner assembly and to the asphalt expander and drum assembly.

8. The warm mix asphalt assembly of claim 1, wherein the warm mix asphalt skid further comprises a housing having an accessible door thereon.

9. A warm mix asphalt assembly comprising:
a warm mix asphalt skid, having a water input pipe, a water output pipe and a control apparatus;
a burner assembly for drying aggregate, the burner assembly comprising:
a single burner apparatus having a centrifugal blower, a transition section, and a frustoconical stabilizer cone from which a flame may exit the burner assembly;
a combustible fuel line having a first end connected to a fuel source, and a second end connected to a nozzle for delivering fuel to a combustion chamber within the single burner apparatus;
a compressed air line having a first end connected to a compressed air source, and a second end connected to a nozzle for delivering compressed air to the combustion chamber; and
a water line having a first end connected to a water source and a second end connected to a nozzle for delivering water to the combustion chamber; and
an asphalt expander and drum assembly, the asphalt expander and drum assembly comprising:
a drum;
an expanded asphalt injection pipe assembly, connected to a water line, and extending into the drum;
a burner apparatus positioned within the drum; and
an asphalt delivery pipe for providing asphalt aggregate into the drum.

10. The warm mix asphalt assembly of claim 9, further comprising:
a control valve for controlling an amount of water provided to each the asphalt expander and drum assembly and the burner assembly.

11. The warm mix asphalt assembly of claim 10, further comprising a first output line for feeding water from the control valve to the burner assembly, and a second output line for feeding water from the control valve to the asphalt expander and drum assembly.

12. The warm mix asphalt assembly of claim 9, wherein the control apparatus comprises a control means for regulating water flow rates to the burner assembly and to the asphalt expander and drum assembly.

13. The warm mix asphalt assembly of claim 9, wherein the warm mix asphalt skid further comprises a housing having an accessible door thereon.

14. The warm mix asphalt assembly of claim 9, wherein during operation of the burner assembly, the flame produces less than about 75 ppm NOx emissions.

15. The warm mix asphalt assembly of claim 9, wherein during operation of the burner assembly, the flame produces less than about 50 ppm NOx emissions.

16. A method of using a warm mix asphalt assembly while producing low NOx emissions comprising:
providing a warm mix asphalt skid, having a water input pipe, a water output pipe and a control apparatus;
providing a burner assembly for drying aggregate, the burner assembly comprising:
a single burner apparatus having a centrifugal blower, a transition section, and a frustoconical stabilizer cone from which a flame may exit the burner assembly;
a combustible fuel line having a first end connected to a fuel source, and a second end connected to a nozzle for delivering fuel to a combustion chamber within the single burner apparatus;
a compressed air line having a first end connected to a compressed air source, and a second end connected to a nozzle for delivering compressed air to the combustion chamber; and
a water line having a first end connected to a water source and a second end connected to a nozzle for delivering water to the combustion chamber; and
providing an asphalt expander and drum assembly, the asphalt expander and drum assembly comprising:
a drum;
an expanded asphalt injection pipe assembly, connected to a water line, and extending into the drum;
a burner apparatus positioned within the drum; and
an asphalt delivery pipe for providing asphalt aggregate into the drum.
operating the burner assembly;
operating the asphalt expander and drum assembly; and
introducing water via the warm mix asphalt skid to both the burner assembly and the asphalt expander and drum assembly.

17. The method of claim 16, wherein during operation of the burner assembly, the flame therein produces less than about 75 ppm NOx emissions.

18. The method of claim 16, wherein during operation of the burner assembly, the flame therein produces less than about 50 ppm NOx emissions.

19. The method of claim 16, further comprising:
providing a control valve for controlling an amount of water provided to each the asphalt expander and drum assembly and the burner assembly.

20. The method of claim 19, further comprising:
providing a first output line for feeding water from the control valve to the burner assembly; and
providing a second output line for feeding water from the control valve to the asphalt expander and drum assembly.
